(19) United States
(12) Patent Application Publication
(10) Pub. No.: US 2019/0287427 A1
(43) Pub. Date: Sep. 19, 2019

(54) DEVICE AND METHOD FOR PERFORMING OBFUSCATED ARITHMETIC

(71) Applicant: KONINKLIJKE PHILIPS N.V., EINDHOVEN (NL)

(72) Inventors: HENDRIK JAN JOZEF HUBERTUS SCHEPERS, VELDHOVEN (NL); PAULUS Mathias Hubertus Mechtildis Antonius GORISSEN, EINDHOVEN (NL); LEANDRO MARIN, MURCIA (ES)

(21) Appl. No.: 16/318,406

(22) PCT Filed: Jul. 17, 2017
(86) PCT No.: PCT/EP2017/067966

§ 371 Date: Jan. 17, 2019

(30) Foreign Application Priority Data
Jul. 21, 2016 (EP) 16180511.4

(51) Int. Cl. G09C 1/00; H04L 9/06

(52) U.S. Cl. CPC G09C 1/00; H04L 2209/16; H04L 9/0631

(57) ABSTRACT

A calculating device (100) arranged to perform calculations on elements of a field (F), a field addition and a field multiplication being defined on the field. Encoded field elements are encoded according to one of at least two different encodings. A calculation manager (130) is arranged to selectively add or multiply a first encoded field element ((a, b)) and a second encoded field element (c, d), by for adding: apply the second translation operator unit to any encoded field element encoded according to the second encoding, and apply the set of addition operator units, and for multiplication: apply the first translation operator unit to any encoded field element encoded according to the first encoding, and apply the set of multiplication operator units.

### FIELD OF THE INVENTION

The invention relates to a calculating device, a calculating method, a computer program, and a computer readable medium.

### BACKGROUND

In computers calculations are performed for various tasks. As computers are finite, these calculations often take place in finite fields. An example of a field is the Galois field with pⁿ elements, with p a prime number. A common example of such fields is arithmetic modulo a prime number. A further popular field for computer arithmetic is the field with 2ⁿ elements. Fields can be constructed in a variety of ways, for example, fields obtained by reduction modulo a polynomial are used in some cryptographic algorithms.

In some applications, there is a desire to hide information about the execution of the program from an attacker. In the so-called white box attack model, an attacker is assumed to have detailed access to a running computer program. There is a desire to hide as much as possible from the attacker, even in this model. In particular, sensitive applications, such as banking applications, content protection, and the like, that use cryptography to hide information from an attacker may be vulnerable in the white box model. If an attacker were to read, say, a secret key that was used to encrypt information, then the attacker may be able to decrypt said information himself, thus obtaining financials, plain content and the like.

In addition to protecting information, there is also, more generally, the desire to protect the calculation itself from an attacker. If an attacker knows exactly where certain algorithms are performed, he may be able to focus his attacks on the right spot in the program; he may be able to reverse engineer secret algorithms, say, proprietary encryption or decryption algorithms.

Protecting a general calculation flow is hard using current white box technology. For example, the paper ‘White-Box Cryptography and an AES Implementation’ by Chow, et al., shows how one particular algorithm (AES) may be protected in the white-box model. This technology may not be directly applied to protect general computer programs, that is, not without extensive human analysis of the program. For example, direct translation, say, of the addition or multiplication operations to tables or table networks of the type described in Chow, would still allow an attacker to deduce when an addition or multiplication is performed, simply by observing which table network is accessed.

### SUMMARY OF THE INVENTION

A calculation device is provided according to the Claims. In the calculation device field elements may be encoded in two different ways. In a first encoding, the encoded field element (x) is represented, but in a second encoding the encoded field element is represented as an exponent (s). In this case the encoded field element equals a generator (g) of the field to the power of the exponent (x=g^{s}).

This has the advantage that operations to define an addition in the first encoding, may be mirrored to define a multiplication. This may be achieved by a first and second translation operator unit that convert a field element from the first to the second encoding and vice versa.

In other words, even if a representation is used that allows a table network, e.g., multiple interdependent table look-ups, a table network of the same structure may be used for addition as well as for multiplication. For example, a set of addition operators may comprise multiple operators that are applied to input elements or to outputs of previous results of the operators.

A convenient first and second encoding are to represent an element x as a list of two elements (a,b). In the first encoding, the element is the difference between two elements (x=a−b). In the second encoding, the element is a generator g to the power of the difference (x=g^{a-b}). This representation has the advantage that an addition may be defined using operators that receive only 3 field elements, rather than 4, and are thus smaller. Moreover, multiplication may also even be expressed as a similar sequence of operators even within the first encoding. Thus a multiplication may be obtained by translating to the second encoding type or by staying in the first encoding; this enlarges the options for obfuscations.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 schematically shows an example of an embodiment of a calculation device 100,

FIG. 2a schematically shows an example of an embodiment of two encoded field elements,

FIG. 2b schematically shows an example of an embodiment of an operator module,

FIG. 3 is a flowchart schematically illustrates a method of calculating,

FIG. 4a schematically shows a computer readable medium having a writable part comprising a computer program according to an embodiment,

FIG. 4b schematically shows a representation of a processor system according to an embodiment.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described above or recited in mutually different dependent claims.

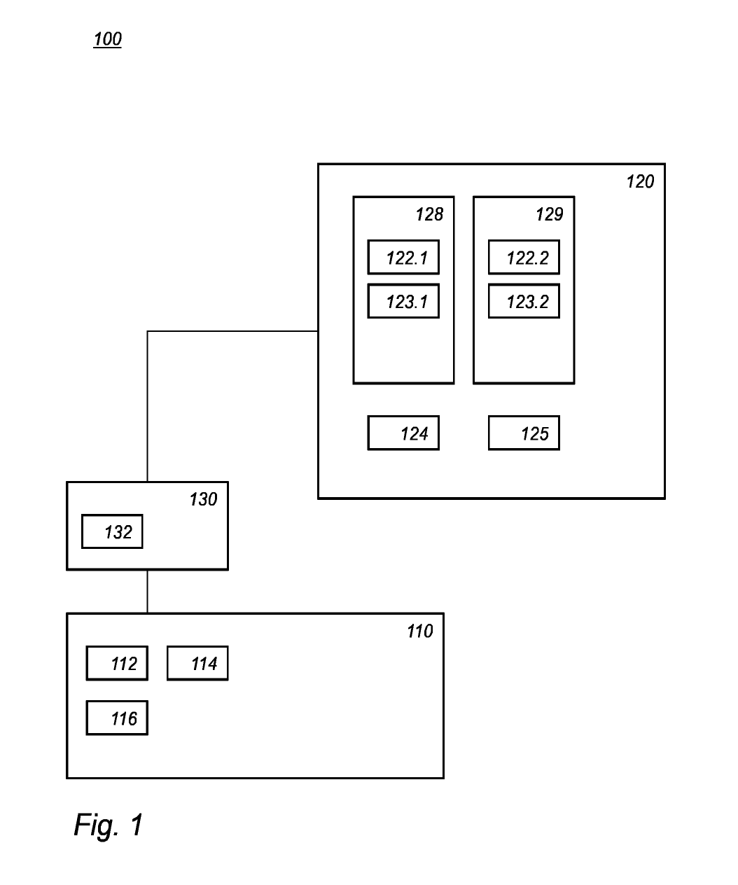

FIG. 1 schematically shows an example of an embodiment of a calculation device 100.

Calculating device 100 is arranged to perform calculations on elements of a finite field F. A field is a mathematical structure having a finite set of elements for which a field addition and a field multiplication is defined. The addition will be denoted as +, the multiplication as ·, or by concatenation. The set of elements together with the addition form an Abelian group, for which the identity is denoted as 0. The field except 0 is an Abelian group under the multiplication, e.g., the multiplication is associative and there is an identity which is denoted as 1. All elements in F have an inverse under the addition, and all except 0, under the multiplication. The addition and multiplication are distributive.

There are many different fields known in the art. For example, the integers modulo a prime number p, e.g., [symbol] ₚ, is a field. For example, p may be an integer such as 5, 17, etc. The set of polynomials modulo a number and a polynomial, [symbol] ₚ[x]/f(x), also form a field if f(x) is an irreducible polynomial. Here x is used as a formal variable, symbolically used to represent one of the elements of the field.

Calculations in various fields are important in many branches of computer sciences. For example, in a binary field, the field element is written as a binary sequence, and an addition corresponds to an XOR operation. For many applications it is important that the calculations are hidden from an attacker on that system. For example, for a security application it may be desired that the exact calculations that are performed remain hidden, as for example, a secret key may be derived from knowing which calculations are performed. Hiding this information is particularly hard if an attacker has full access to the computer software code while it is executing. Although different obfuscation techniques are known in the art, there remains a desire to further improve obfuscation of calculations in fields.

Other arithmetic, e.g., arithmetic modulo a number M, say, modulo 2³², that is in the ring [symbol] ₂_{³²} rather than the field GF(2³²), may be modelled by performing arithmetic in a larger field. For example, by selecting a prime number p>2M, e.g., p=2⁶⁴+13, and performing arithmetic in [symbol] ₚ and subtracting M whenever operands become larger or equal to M.

Calculating device 100 comprises an operand store 110 which is arranged to store encoded field elements. FIG. 1 shows encoded field elements 112, 114, and 116. There are various ways to encode a field element. An encoded field element represents an element of the field in encoded form. Some encodings are discussed below. For an encoding there exists a decoding mapping, e.g., a decryption, which maps an encoded field element to a plain field element, e.g., in some conventional notation, e.g., a canonical notation; and an encoding mapping, that maps a plain field element to an encoded field element. A given field element may be encoded in various ways, e.g., the encoded field elements need not be unique. In such a case, the decoding is a many-to-one mapping. Having multiple different encoding improves security as it makes it harder to construct a table that maps encoded to plain field elements.

Calculation device 100 uses at least two different encodings. The first encoding may be any encoding of the field F. For example, the first encoding may represent a field element as a list of field elements. In an embodiment, an advantageous encoding for the first encoding is the difference encoding, in which a field element x is represented as a pair of field elements (a,b), so that field element x is the difference between two field elements (x=a−b). The second encoding encodes a field element as the exponent of a generator element. For example, the second encoding may be difference exponent encoding, in which a field element x is represented as a pair of field elements (a,b), so that field element x is generator to the power of the difference between two field elements (x=g^{a-b}).

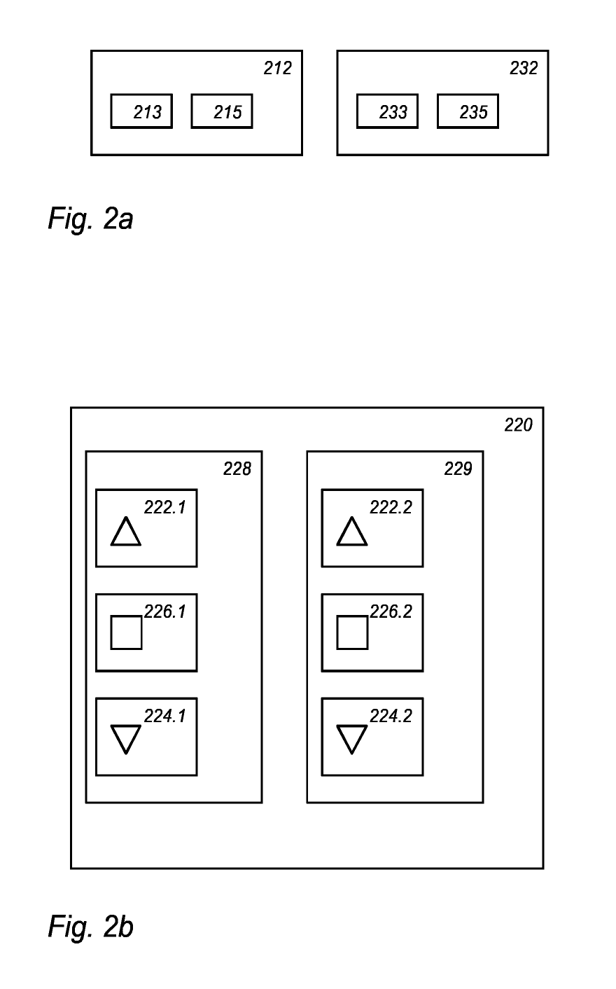

FIG. 2a schematically shows an example of an embodiment of an encoded field element 212. Encoded field element 212, is encoded as a list of two field elements 213 and 215. Thus in this way of encoding the same field is used to represent its members in an encoded fashion. In mathematical notation, the field element x may be encoded as the list (a,b) of field elements.

For example, in an embodiment, the encoded field element is the difference between said two field elements (x=a−b).

A representation as a pair (a,b) may be further restricted. Since the encoded field elements will later be used as the input to operand units, typically implemented as look-up tables, there is an advantage in reducing the number of possible representations of a field element. This may be done by restricting the elements (a,b) to a so-called difference set of F. A difference set, is a subset of a larger set, typically a field or a ring, such that any element of the larger set may be expressed as a difference of elements of the difference set. This in turn restricts the size of operator units if they are implemented as tables. If the larger set comprises 0 than a difference set always exists.

In an embodiment, both elements of the list are elements of a difference set. Note that additional constraints imposed on the representation may be reflected in table operations. For example, the box operator (see below) may be represented as a table; if difference representations are used, the output of the box operator may be restricted in the same manner, etc.

How much the number of representation may be reduced by requiring the elements of a list representation to be members of a difference set depends on the required security. If there are more different representations of an element, then there is less information obtained from knowing just one of the elements. In fact, if all representations are allowed, then knowledge of one of the field elements in an encoding of a field element gives no information on the element that is encoded.

For example, to encode an element r as a difference, one may choose a random element x of the field, after which r may be represented, e.g., as r=(r−x)−x, or r=x−(x−r), or as the tupples ((r−x,x) or (x,(x−r)). Encoding for the more restricted representation may be done by enumerating all differences between elements of the set and sorting the list.

Generally, the field elements in an encoded field representation, e.g., a list representation, need not be plain field elements, but may themselves be encoded to further obfuscate the system. Thus an attacker who reverse engineers a program and finds the two elements a and b does not immediately know the difference a−b. This encoding may be a straightforward bijection of the field to itself. Any look-up table taking the encoded elements as inputs can take the bijection into account, as is usual in the art. For example, a bijection E from the field to itself may be defined, in this case if x=a−b, then the representation (a,b) may be stored in operand store 110 as Ea and Eb. There is also no need for these two numbers to be stored next to each other.

The encoding E does not need to be a bijection. For example, suppose we have a domain A={0,1} and a range B={0,1,2}. Note, that the size of B is larger than that of A. A relation E from A to B can be given by {(0,0), (1,1), (1,2)}, where (a,b), with a in A and b in B should be interpreted as “can be mapped to”. This introduces a choice in the encryption of the element 1 from A. What is needed in the relation E is that it is invertible.

FIG. 2a further shows an encoded field element 232, like encoded field element 212, encoded field element 232 comprises two field elements 233 and 235. In mathematical notation, the field element x may be encoded as the list (a,b) of field elements.

For the second encoding, we start from the observation that for any field there is an element g, called a generator, so that any element x≠0 of the field can be expressed as gⁱ for some i. If the number of elements of the field F is denoted as n, the order of g is n−1, that is gⁿ⁻¹=1. A mapping can thus be defined from the field F to [symbol] ₙ₋₁, which maps x to i. In the second representation any non-zero element of the field can be represented by two elements (a,b) such that i=a−b, and thus x=g^{a-b}. This leaves how to represent the number 0. This may be resolved by assigning one special element as minus infinity (−∞). This number has the property that g^{-∞}=0, e.g., by definition. The second encoding may be defined as

(a,b) maps to g^{a-b} if both a and b are not equal to −∞

(a,b) maps to 0 if any one of a and b are equal to −∞.

The cardinality of the set [symbol] ₙ₋₁∪{−∞} equals the cardinality of the field F.

In an embodiment, the elements used in a second encoding may be integers {0, . . . , n}, wherein, e.g., the integers {0, . . . , n−1} are elements unequal to −∞, and wherein the integer n takes the part of −∞. However, any other integer could also be used as −∞. In fact, through a bijection any number may be represent by any number.

Also in the second encoding, may we restrict the elements a and b to some subset of [symbol] ₙ₋₁∪{−∞}.

For example, in an embodiment, two bijections are defined E_{1,i} from the field F to the integers 0 to n−1 (inclusive), and two bijections E_{2,i} from the [symbol] ₙ₋₁∪{−∞} to the integers 0 to n−1 (inclusive). The two bijections may be randomly chosen, e.g., at compile time. An element x=a−b may be stored in the first encoding as the pair (E_{1,2}(a),E_{1,2}(b)), and element x=g^{a-b} may be stored in the second encoding as the pair (E_{2,2}(a),E_{2,2}(b)), the element 0 may be represented by setting any one of a and b to minus infinity.

For example, consider the field GF(256), the field with 256 elements. The elements of GF(256) may be regarded as polynomials in x of degree ≤7 with coefficients in GF(2). GF(2) is just {0,1} with binary addition and multiplication, but there are no carries: 1+1=0 in GF(2). For example, AES encryption uses the following reducing polynomial to define the field: x⁸+x⁴+x³+x+1. Other irreducible polynomials may be used in this case. In general, any field may be implemented by choosing a suitable irreducible polynomial.

The elements of a field, in particular, the field GF(256) used in AES, may be thought of as binary polynomials. There are 256 elements in all (hence the name GF(256).

Addition of 2 polynomials in GF(256) is straightforward. This is just normal addition of polynomials, but the coefficients of the calculations take place in GF(2). The latter may be regarded as an XOR operation.

To multiply 2 polynomials in GF(256), first you multiply the polynomials just like ordinary polynomials but again, remembering that the calculations take place in GF(2). Then divide the result by the reduction polynomials and take the remainder.

The elements of this field may be represented as a binary string wherein each bit represents a coefficient of an exponent of the formal variable x. In practice, this is not needed though, as any bijection between the field and the integers 0 to 255 may be used to represent the field elements. In the latter case addition and multiplication operations in a field element may be performed using a look-up table.

The field GF(256) has many generators, e.g., the element 1+x. We will refer to the generator element as g. Note that gⁿ⁻¹=1, wherein n is the size of the field (256 in this example). That is (1+x)²⁵⁵=1 mod x⁸+x⁴+x³+x+1.

To encode an element in the first encoding, say the element x⁷+x⁵+x³+x using the representation with a formal variable x, or the element 10101000 when represented as a binary string, we may pick a random element a, say 11011100, and compute the difference with 10101000 to obtain 01110100. As this example uses a binary field, this is an XOR operation. So 10101000 may be encoded according to the first encoding as (11011100, 01110100); or equivalently (220, 116). Note, in an actual embodiment, different strings may be used as the strings may be stored itself in an encoded form as well. The latter encoding may be any conventional encoding, e.g., a random bijection, etc. The encoding on this level needs to be distinguished from the encoding in multiple elements.

To encode the element x⁷+x⁵+x³+x according to second encoding we note that x⁷+x⁵+x³+x=(1+x)³¹ mod x⁸+x⁴+x³+x+1. Note that the generator 1+x is an arbitrary choice which may be implied in the implementation of the operators, and need not be explicit. In the second encoding the exponent 31 is a number between 0 and 254, and may be represented as a difference between two integers, say two integers between 0 and 254 inclusive. The integers are modulo 255 (one less than the order of the field). For example, set a=17 and choose b so that a b=31 mod 255, so that b=241. The element encoded according to the second encoding may be (17, 241). To represent the element 0, we enlarge the numbers 0 to 254 with the element minus infinity (−∞). The difference between any two numbers at least one of which is minus infinity, is again minus infinity. For example, me have the integer 255 represent the additional number minus infinity. We define that g^{-∞}=0. The number 0 may be represented as (255, a), (a, 255), (255, 255) for any a between 0 and 254. Also for the second encoding, an embodiment need not store that actual numbers underlying the encoding, e.g., 17, 241, and 255 in the example above but instead any bijection from the integers 0 to 255 to itself may be used to encode the numbers in the second encoding. Encoding of the exponent may be done according to the system described in WO/2016/102445, e.g., claim 1 thereof.

As with any two encodings, an element encoded according to the first encoding may be translated to the second encoding, e.g., using a look-up table. If multiple representations are possible this may be used, e.g., by having one or more alternative in the look-up table. In an example, multiple look-up tables are used so that an element is translated in different ways by two look-up tables.

Many alternative first/second encodings are possible that preserve the possibility of having a multiplication and addition defined by a similar sequence of operator units. In general, an element x may be represented as a list of elements, e.g. a vector v of elements, so that l₁·v=x (first encoding) or l₂·v=s, with g^{s}=x (second encoding). Here the encoding is defined by the vector l. For example, the difference encoding may be obtained using l₁=l₂=(1, −1). The up/down/box operators may be defined for different l in a similar manner, so long as l maps to the full field, and not to a sub group thereof. This may be achieved, by having at least 1 unit in the vector l. In an embodiment, l has two elements.

In an embodiment, the two field elements in an encoding are represented as exponents ((α,β)). The two field elements being the exponent of a common base element (u) of the field raised to the power indicated by the exponent (x=u^{α}−u^{β}). This means that the encoded field element (α,β) corresponds to the plain field element x=u^{α}−u^{β}. This type of encoding may be referred to as log-form. To avoid confusion, we may write (α,β)ᵤ, if we want to make it explicit that log-form is used. Also in this case the exponents may be restricted to a set, and/or encoded.

Returning to FIG. 1. Operand store 110 may comprise constants. For example, constant field elements that are used in some algorithm, say, in some cryptographic algorithm, such as an encryption, decryption, a MAC operation (message authentication code), signing, signature verification, and the like. Operand store 110 may also comprise field elements that are input by a user, or are received from a computer, e.g., external to calculation device 100. Calculation device 100 may comprise an encoding unit to translate received plain field elements to encoded field elements and/or a decoding unit to translate encoded field elements to plain field elements, e.g., before sending them, e.g., to the external computer. The encoding and decoding units may be restricted to only one type of encoding, e.g., only the first type of encoding. In this case the translation tables may be used to encode or decode elements to and from the second type.

Calculation device 100 may also receive external field elements directly in encoded form. Outside calculation device 100 another encoding, say, encryption may be used, than inside of calculation device 100.

Some of the field elements in operand store 228 may be encoded according to the first encoding and some according to the second encoding. In an embodiment, at least some field elements in operand store 228 are encoded according to the first encoding and at least some according to the second encoding.

Calculation device 100 comprises an operator module 120. Operator module 120 comprises multiple operator units. An operator unit may be implemented as a single look-up table, or as multiple look-up tables, e.g., as a look-up table network. An operator unit may also be implemented as multiple computer instructions arranged to perform the function of the operator unit. The operator units may be stored in an electronic memory of calculating device 100. Operator module 120 comprises a first translation operator unit 124 arranged to receive a field element encoded according to the first encoding, and to produce the same field element re-encoded according to the second encoding, and a second translation operator unit 125 arranged to receive a field element encoded according to the second encoding, and to produce the same field element re-encoded according to the first encoding.

Furthermore, calculation device 100 comprises a set 128 of addition operator units, and a set 129 of multiplication operator units. In addition set 128 two operators are shown: 122.1 and 123.1. In multiplication set 129 two operators are shown: 122.2 and 123.2

Note that unit elements are not to be confused with the units of a device. The latter are operative parts that perform a certain function, the former are elements of a set that have a multiplicative inverse.

Interestingly, the set 128 of addition operator units are arranged to add two field elements encoded according to the first encoding. The set 129 of multiplication operator unit is arranged to add two field elements encoded according to the second encoding in the second encoding so that after translation to the first encoding they are multiplied. This makes use of the correspondence g^{x}g^{y}=g^{x+y}. Note that this relationship also holds if one of x and y are minus infinity, as in that case x+y is also minus infinity and thus both sides of the equation represent the number 0.

For example, consider the field elements x and y. The following operations are possible:
If the two field elements are encoded according to the first encoding, they may be added by applying set 128.
If one or both of the two field elements are encoded according to the first encoding, they may be multiplied by translating them to the second encoding and applying set 129,
If the two field elements are encoded according to the second encoding, they may be multiplied by applying set 129.
If one or both of the two field elements are encoded according to the second encoding, they may be added by translating them to the first encoding and applying set 128.

The translation units may be monadic operator unit. However, they can be made to receive a parameter as well, e.g., to select among multiple different representations.

At least one of the multiple operator units is a dyadic operator unit. FIG. 1 shows dyadic operator units 122.1 and 122.2. Operator module 120 may also contain one or more monadic operator unit. FIG. 1 shows monadic operator units 123.1 and 123.2.

A dyadic operator unit such as dyadic operator unit 122.1/2 is arranged to
receive an encoded field element and a parameter, and
perform a fixed calculation on said encoded field element and the parameter, thus producing a new encoded field element.

A monadic operator unit such as monadic operator unit 123.1/2 is arranged to
receive an encoded field element, and
perform a fixed calculation on said encoded field element, thus producing a new encoded field element.

In both the dyadic and the monadic case the encoded field element may be received from operand memory 110, e.g., through a calculation manager 130 (further discussed below). For the dyadic case, the parameter may also be received from operand memory 110, e.g., through a calculation manager 130.

The calculation performed by an operator unit is fixed. If an operator is presented with a different parameter or encoded field element it will execute the same set of computations, albeit with different inputs. For example, the calculation of an operator unit may comprise (or even consist of) field arithmetic on the parameter or its inverse and elements of the encoded representation. For example, the calculation of an operator unit may comprise (or even consist of) field multiplications and field additions. The field multiplication, including the latter, may be a multiplication with a fixed field element (e.g., −1).

Calculation device 100 comprises a calculation manager 130. Calculation manager 130 is arranged to receive a first encoded field element and a second encoded field element. For example, calculation manager 130 may be arranged to fetch a first encoded field element and a second encoded field element from operand memory 110. For example, calculation manager 130 may fetch encoded field elements 112 and 114. The information which type of encoding the field elements used may be stored in calculation device 100, e.g., in operand memory 110. However, it is possible to keep this information implicit, e.g., in the process flow, e.g., as defined in a computer program executed by calculation manager 130 that is arranged to apply a translation unit as needed.

Calculation device 100 can both perform a field addition and a field multiplication on a first encoded field element and a second encoded field element. Which operation is chosen, the addition or the multiplication, depends on the application for which calculation device 100 is adapted. For example, a cryptographic operation may be performed that requires a large number of arithmetical operations to be performed including both multiplications and additions.

Calculation manager 130 is arranged to perform a field addition on elements encoded according to the first encoding. Calculation manager 130 is arranged to apply a sequence of the multiple operator units in addition set 128 to the first encoded field element using parameters obtained at least from the second encoded field element. For example, each operator unit may be applied to the first encoded field element in some particular order, some of which may be applied multiple times. For example, the sequence may apply a first operator, then a second operator, then a third operator, then the third operator again, and so on.

Similarly, calculation manager 130 is arranged to perform a field addition on elements encoded according to the second encoding (effecting a multiplication if the elements are translated to the first encoding). Calculation manager 130 is arranged to apply a sequence of the multiple operator units in multiplication set 129 to the first encoded field element using parameters obtained at least from the second encoded field element.

Interestingly, the computer instructions that calculation manager 130 may use for addition in the first or second encoding may be indistinguishable apart from addresses and content of the tables applied. In particular, the number of tables applied to perform an addition in the two encoding domains may be equal. Furthermore, the order and origin of parameters may be equal.

In fact, a first one-to-one mapping may be defined between the set of addition operator units and the set of multiplication operator units, a sequence of operating units in the set of addition operator units applied for adding being mapped one-to-one by the first mapping to a sequence of operating units in the set of multiplication operator units applied for multiplication.

The same may be done for parameters used in the dyadic operator unit. For example, a second one-to-one mapping is defined between the input elements, output elements and parameters of the dyadic operators in the set of addition operator units and the input elements, output elements and parameters of the dyadic operators in the set of multiplication operator units.

Calculation manager 130 could be arranged to perform a field multiplication directly on field elements according to the first encoding. This could even be arranged so that the number and order of operators is the same as for addition on field elements encoded according to the first encoding, however, the parameters used in such a multiplication would be different.

It is considered that distinguishing parameters is easier than distinguishing tables. In a white-box implementation a lot of operator units are typically used. For operations multiple operator units may be defined, e.g., for different encodings. Dummy operator units may not do anything or only change encoding etc. However, a different use of parameters may potentially be tracked by flow analysis, and such analysis may be automated. Furthermore, in an embodiment, both approaches—hiding table use but using a different parameter flow and hiding parameters by using translation tables—may be combined.

For example, calculation manager 130 may comprise or have access to a sequence of operators 132. The sequence of operators determines which operators are performed on which encoded field elements. Sequence 132 may comprise sub-sequences that represent a field addition and sub-sequences that represent a field multiplication. The sub-sequences may be mapped to each other under a bijection. Sequence 132 may also include further applications of the multiple operators, e.g., translation operators, or even other, possibly unrelated operators. Sequence 132 may be included in a program. Sequence 132 may be stored in a memory, say, in operand store 110.

An attacker who analyses the operation of operator module 120 will see the same sequence of operations regardless of the fact that an addition or a multiplication is performed. Thus the attacker cannot deduce information about the calculation that is performed from an analysis of the operations. In this way an important aspect of the running of the calculation device is hidden from the attacker.

Moreover, in an embodiment, obfuscation techniques may be applied to the system. In particular, the multiple operations may be executed as look-up tables. The encoded field elements may have a random relationship, e.g., through encryption, or a random encoding, with the plain field elements. Although an attacker may be able to see which tables are applied and which order to execute the various operator units, he cannot deduce information therefrom since the sequence for a field addition and field multiplication has become meaningless. In fact, in both cases an addition is actually performed. At the same time the parameters have become less useful as well since their use is the same in both cases.

Monadic operations are particularly suitable for implementation as a look-up table since the size of a table increases strongly with the number of inputs. For example, calculating device 100 may comprise a storage that stores a look-up table implementing the box operator unit (see below).

In addition to field multiplication and field addition, the calculation device 100 may be arranged for other operations on field elements. For example, calculation device 100 may comprise a storage comprising a table that represents an operation that cannot be (easily) represented as a sequence of addition and multiplications.

In addition to field addition and field multiplication other operations may also be expressed using the same sequence of the same operators. For example, in an embodiment, calculation manager 130 is arranged to perform a field subtraction by applying a sequence of the multiple operator units to the first encoded field element using parameters obtained at least from the second encoded field element, wherein the sequence for the field subtraction is the same as the sequence for the field addition and the sequence for the field multiplication. For example, negation operations may also be expressed in this way.

During operation, device 100 may be used, e.g., as follows. Calculation device 130 fetches a first and a second encoded field element from operand storage 110. Calculation device 130 applies a first or second translation if needed and selects operator units from operator module 120; for example, according to sequence 132 and causes the selected operator unit to be applied to the first encoded field elements. Intermediate results of the application may be stored in operator store 150, e.g., as encoded intermediate field elements. Calculation device 130 may compute the required parameters.

Protection may further use hardware security measures, but may in particular also be software protection such as obfuscation. Obfuscation is more effective if the operand selection of calculation manager 130 is independent from the parameter calculation. Particular effective software protection includes the application of white box cryptography.

In an embodiment, the operand module 120 comprises
a first dummy translation operator unit arranged to receive a field element encoded according to the first encoding, and to produce the same field element re-encoded according to the first encoding, and/or
a second dummy translation operator unit arranged to receive a field element encoded according to the second encoding, and to produce the same field element re-encoded according to the second encoding.

For example, the dummy translation may map an input field element to a different representation of the same field element in the same encoding type. For example, the control module 130 may be configured to apply a translation table each time an addition or multiplication is to be performed, e.g., by applying a dummy translation table if no actual translation is needed. In this way the sequences for addition and multiplication are even further equal.

In an embodiment, calculating device 100 comprises a parameter unit arranged to compute the parameters obtained at least from the second encoded field element for performing the field multiplication and field addition by the calculation manager. For example, calculation manager 130 and parameter unit may be implemented as distinct and different circuits. Such a calculation system may be geographically distributed in which calculation manager 100 and a parameter unit may be geographically separated from each other. For example, the geographic separation may be more than some desired distance, more than say 10 km, etc.

Calculation device 100 may be embodied in a virtual machine. In this case, sequence 132 may be part of the program that runs on the virtual machine. Conventional virtual machines (VMs) provide basic operations amongst which the addition, subtraction, multiplication, mutual exclusion and so on. The objective of this is twofold: the virtual machine provides operations and primitives which are, as such, not provided by the underlying platform, and enables a compact instruction format which is particularly useful in memory constrained environments.

However, many of the instructions of the VM still are the basic ones like addition, subtraction, multiplication, et cetera, which are directly mapped onto instructions of the underlying platform. Since these are generally well understood a VM can be quite easily attacked through the analysis of the power consumption and the injection of faults. What is more, because of this mapping it is quite easy to add tracing instructions to individual operations.

A virtual machine according to an embodiment alleviates this situation. The virtual machine has instructions for the up, down and box operation, e.g., as part of the instruction set of the VM. The instructions may only be available in a special operation mode, e.g., a security mode.

The relationship between sequences of these operations and the actual functions being performed is less direct. In practice, code to perform the arithmetic could look like:

1. (optionally) changing the mode (for instance, by assigning some address), followed by

2. a sequence of up, down and box instructions implementing the arithmetic and

3. (optionally) ending with a mode change again.

Given the number of algebraic fields and the variations in the possible representations every virtual machine could have its own arithmetic.

The virtual machine may differentiate between the executions of the up, down, and box instructions and the computation of the index (the parameter). For example, these activities may be split.

For example, one activity may be the (pre-)fetch of the sequence of operations, the other activity may be the actual looking up of the outcome of instructions. The pipeline of these activities may in fact be the actual execution model.

The up, down and box operations may be implemented using tables, which also facilitates encoded implementation. The use of a table driven approach is even possible in memory constrained environments, since with the right choice of the underlying field R the newly defined arithmetic needs only small tables.

The consecutive up and down instructions may be combined, for example, ΔᵣΔₛ=Δₛᵣ, ∇ᵣ∇ₛ=∇ₛᵣ, Δᵣ=∇ᵣ⁻¹, etc. Any two consecutive up or down instructions can be rewritten as a single up or down instruction using these rules. An embodiment of the calculating device or of the virtual machine comprises a combining unit. The combining unit may cooperate with calculation manager 130 and combine operators planned by calculation manager 130 before they are executed.

The combining unit combines two consecutive up, down, or box operations and combines them into a single new operation, according to one of the above rules. Combining unit then combines the corresponding parameters accordingly. This type of combining has the advantage that parameters do not correspond with a single operation anymore but with a combined operation. A combining unit may also be a stand-alone device, e.g., to obfuscate a given sequence. The combining unit may be integrated with a compiler which generates the sequence of operators.

FIG. 2b schematically shows an example of an embodiment of an operator module 220. This embodiment comprises a set 228 of addition operator units, and a set 229 of multiplication operator units. Each set 228, 229 comprises three operator units: two dyadic operator units 222.1/2 and 224.1/2 and one monadic operator unit 226.1/2. When referring to the same type of operator units in a different set, we use the index 0.1 or 0.2 to indicate they are in set 228 or 229. We may omit the index, or use the index 0.1/2 to indicate that the statement applies to both the operand of set 228 and set 229.

Embodiments may use more or fewer operator units. Below we will first assume that a field element x is encoded according to the first encoded, as a list (a,b) of two field elements such that x=a−b. In an embodiment, the field F has at least 4, or at least 8 elements, etc. Although the representation in an embodiment may be complicated and/or further encoded, we will not include this below, so as to avoid confusing the discussion.

We will refer to the operator units 222.1/2, 224.1/2, and 226.1/2 in operator module 220 as: a (dyadic) up operator unit 222.1/2, also notated as Δ; a (dyadic) down operator unit 224.1/2, also notated as ∇; and a monadic box operator unit 226.1/2, also notated as □. The names up, down and box have been chosen for convenience, but do not carry meaning in themselves. The operators 222.1/2, 224.1/2, 226.1/2 may equally be referred to as a first operator unit, second operator unit and third operator unit. The parameter in a down and up operator may be indicated as a subscript.

Dyadic up operator unit 222.1/2, Δ is arranged to
receive a representation for a first field element (a) and a second field element (b), the encoded field element (x) being the difference between the first field element and the second field element (x=a−b), and to receive a parameter field element (c), and
calculate the first field element field multiplied with the inverse of the parameter (ac⁻¹) and calculate the second field element field multiplied with the inverse of the parameter (bc⁻¹), the new encoded field element (y) being represented by the results of said two calculations (y=ac⁻¹−bc⁻¹).

Mathematically, the up operator may be defined by Δ_{c}((a,b))=(ac⁻¹,bc⁻¹). In this formula, c is the parameter, and (a,b) is the first encoded field element. The encoded field element (a,b) encodes the field element x=a−b. The output of the up operator is itself also in encoded form, thus, encoding the element ac⁻¹−bc⁻¹.

Dyadic down operator unit 224.1/2, ∇ is arranged to
receive a representation for a first field element (a) and a second field element (b), the encoded field element (x) being the difference between the first field element and the second field element (x=a−b), and to receive a parameter field element (c), and
calculate the first field element field multiplied with the parameter (ac) and calculate the second field element field multiplied with the parameter (bc), the new encoded field element (y) being represented by the results of said two calculations (y=ac−bc).

Mathematically, the down operator may be defined by ∇_{c} ((a,b))=(ac,bc), in this formula, c is the parameter, and (a,b) is the first encoded field element. The encoded field element (a,b) encodes the field element x=a−b. The output of the up operator is itself also in encoded form, thus, encoding the element ac−bc.

Note that technically the parameter c and inputs a and b for both the up and down operator are taken from the range of the field F in the first encoding or from [symbol] ₙ₋₁∪{−∞} in the second encoding. Note that they have the same size and may be represented in the same way in an embodiment, e.g., a bit string of equal length. In an embodiment, the elements in a representation according to the second embodiment is restricted to units of [symbol] ₙ₋₁ and −∞. The operators in the multiplication set, e.g. operators 222.2, 226.2, and 224.2 may be adapted to produce only encodings consisting of units of [symbol] ₙ₋₁ and −∞. To keep the number of representations of the first type equal, encodings of the first type may be restricted to a difference set of the same size as used for the second type, e.g., of the number of units +1.

Box operator unit 226.1/2, □ is arranged to
receive a representation for a first field element (a) and a second field element (b), the encoded field element (x) being the difference between the first field element and the second field element (x=a−b),
obtain the negation of the encoded field element (x) plus a fixed increment (−(x+1)=−x−1) in encoded form.

Mathematically, the box operator 226.1/2 may be defined by □((a,b))=(k,l), in which k−l=−(x+1)=−x−1. Note that there may be multiple choices for (k,l). The box operator may always pick the same choice, which may be a random choice, or a choice within some restriction on the encoded representation. Below we will assume that (k,l) are both units or minus infinity. The box operator may be expressed as the map (a,b) to (b, a+1), using the field addition. This monadic operation is suited for expression as a table. In [symbol] ₙ₋₁ in which some non-zero elements may not be units, a table can select a representation that satisfies any unit requirement (e.g., the first element of the representation is unit, the second element is unit, or both elements are units). Moreover, a table need not follow any particular formula expressed as an elementary expression (involving only field addition, subtraction, multiplication and multiplicative inverses) for all inputs; and in particular, does not need to follow the expression given above.

All of the operators 222.1/2, 224.1/2 and 226.1/2 may be implemented as a table. For the box operator this is a natural choice. The up and down operators 222.1/2 and 224.1/2 could also be implemented using field arithmetic, e.g., the same field arithmetic that is obfuscated by the calculation device.

Whenever any one of the inputs or parameter of the operators 222.2, 224.2 is minus infinity, the outcome may be defined, e.g., as the point (−∞,−∞). Whenever any one of the inputs of the box operators 226.2 is minus infinity, the outcome may be defined, e.g., as the point (−∞,−∞), (−∞,a), or (a,−∞), for some integer a≠−∞.

In general, by setting at least one output element to minus infinity whenever any one of the input/parameters of an operator of the multiplication set 129, 229 is minus infinity, this ensures that whenever any one of the a first encoded field element and a second encoded field element which are multiplies by calculation manager 130 is a representation of 0 and has a minus infinity element, the end result of apply the multiplication set will also have a minus infinity element and is therefore a representation of 0. In short, always propagating a minus infinity in the input to the output ensures that a multiplication with 0 will have 0 as the result.

Given a first encoded field element and a second encoded field element represented as (a,b) and (c,d) respectively (both encoded for the same type), below a sequence is given to field add in the encoding. The effect will be
if the first encoded field element and a second encoded field element are encoded according to the first encoding, the result is an addition encoded according to the first encoding,
if the first encoded field element and a second encoded field element are encoded according to the second encoding, the result is a multiplication encoded according to the second encoding (seen from the perspective of the second encoding the two representations are added).

The elements of the first encoded field element and a second encoded field element may be referred to as the first first field element (a), first second field element (b), the second first field element (c), and the second second field element (d).

The field addition may be represented as follows:

(a,b)+(c,d)=(∇_{d}∘□∘Δ_{d}∘∇_{c}∘□∘Δ_{c})((a,b))

In this formula function composition is indicated with 0. For example,
first the up operator unit 222 is applied to the first encoded field element (a,b) using parameter c, then
the box operator 226 is applied to the result of the previous operator, then
the down operator unit 224 is applied to the result of the previous operator using parameter c, then
the up operator unit 222 is applied to the result of the previous operator using parameter d, then
the box operator 226 is applied to the result of previous operator, then
the down operator unit 224 is applied to the result of the previous operator using parameter d.

The sequence of operator references may be, e.g., 224, 226, 224, 222, 226, 222 (in this case the first operator is to the left). The sequence of parameters may be, e.g., c, −, c, d, −, d, in which no parameter is indicated with a hyphen.

Note that a multiplication could be defined using the same operators, for field elements encoded according to the first encoding. The field multiplication may be represented as follows:

(a,b)·(c,d)=(∇_{ad}∘□∘Δ_{ad}∘∇_{bd}∘□∘Δ_{cbd})((a,b))

For example,
first the up operator unit 222 is applied to the first encoded field element (a,b) using parameter cbd, then
the box operator 226 is applied to the result of the previous operator, then
the down operator unit 224 is applied to the result of the previous operator using parameter bd, then
the up operator unit 222 is applied to the result of the previous operator using parameter ad, then
the box operator 226 is applied to the result of previous operator, then
the down operator unit 224 is applied to the result of the previous operator using parameter ad.

The sequence of operator references may be, e.g., 224, 226, 224, 222, 226, 222 (in this case the first operator is to the left). The sequence of parameters may be, e.g., cbd, −, bd, ad, −, ad, in which no parameter is indicated with a hyphen.

Although this operation is also very similar when regarding the tables used, some information may be gleaned from the fact that some a multiplication on the field level is needed. Translating to the second encoding avoids this problem.

A subtraction may be effected by negating one of the elements, e.g., by a swap of the elements in the first representation. A division may be effected by multiplying with the inverse. An inverse may be obtained by swapping the elements in the second representation. Note that the element 0 is mapped to 0 in this way.

Alternatively, a field subtraction may be obtained by performing in the first encoding respectively: (a,b)−(c,d)=(∇_{c}∘□∘Δ_{c}∘∇_{d}∘□∘Δ_{d})((a,b)).

For example,
first the up operator unit 222 is applied to the first encoded field element (a,b) using parameter d, then
the box operator 226 is applied to the result of the previous operator, then
the down operator unit 224 is applied to the result of the previous operator using parameter d, then
the up operator unit 222 is applied to the result of the previous operator using parameter c, then
the box operator 226 is applied to the result of previous operator, then
the down operator unit 224 is applied to the result of the previous operator using parameter c.

The sequence of operator references may be, e.g., 224, 226, 224, 222, 226, 222 (in this case the first operator is to the left). The sequence of parameters may be, e.g., d, −, d, c, −, c, in which no parameter is indicated with a hyphen.

In the same way a division can be obtained using the second representation.

Other sequences that have the property that they can represent addition and multiplication in the first and second encoding respectively may be devised. For example, by substituting a new operator unit which is the combination of the box and up operator (□∘Δ) in the above formula's, new sequences are obtained. An interesting variant is obtained by combining ∇_{c}∘□∘Δ_{c} in to a single dyadic operator. In this case no box operation is needed. The addition and multiplication sets only have one element in this case. Many other possibilities exist. In an embodiment, sets 128 and 129 each comprise multiple elements.

That the above formulas are correct may be verified by substituting the corresponding definitions of the operator units and following the mathematical derivation.

Different options exist for the encodings. For example, the list of two field elements in an encoding may be represented as exponents ((α,β)), the two field elements being the exponent of a common base element (u) of the field raised to the power indicated by the exponent (u^{α}−u^{β}). This representation is referred to as log-form, a lower case u may be added to distinguish this representation. The base element is selected as an element such that the set of powers of u is a difference set for F (in case of the encoding of the first type) or of [symbol] ₙ₋₁∪{−∞} in case of encodings of the second type. We use the convention that u^{-∞}=0.

A generator will be a possible choice for the base element u, however it is not needed. Consider for example, the field with 256 introduced in an example above, the formal variable x is not a generator of GF(256) since x⁵⁵=1, however, the powers of x clearly form a difference set.

Different encoding for the field elements may give different formulas for the operators. For example, the above description for the up, down, and box operator may be adapted to similar formulas if the encoding is in log form. Another variant is to represent an element as x which has log form (α,β)ᵤ as the list of field elements [β,δ] wherein δ=α−β, that is x=u^{β+δ}−u^{β}. Also in this form, the operators may be expressed. For example, the up operator would become Δ_{y} ([β,δ])=[β−γ,δ]. The down operator would be the same, except with +y instead of −y. The box operation may be defined using the same relation as before.

Other sequence of operators exist that may also be used to create a sequence of operators so that the sequence for the field multiplication is the same as the sequence for the field addition. For example, in an embodiment, 2, 3, or more operators are defined operating on the elements of a list representation of an element of F. Some of the operators, say 1 or more, or 2 or more, or all but one, are pre-defined sequence of field-operations operating on the elements of the list representation of two elements of F. The pre-defined sequence of field-operations may be expressed as an expression involving the field multiplication and field-multiplicative-inverse operations, and optionally also involving field-addition and field-subtracting. Some of the operators, say exactly 1, 1 or more, etc., are monadic and represent a fixed operation on the field element, for example, a fixed expression involving field addition and the additive-inverse (the minus, ‘−’, operation); this operation may be expressed as a table operation. Although that is not necessary. In an encoded embodiment, the elements of the list representation may be encoded. The field operations, addition, multiplications, multiplicative and additive inverses etc., may be then be implemented as encoded tables, or table networks. The list representation may be defined as a sequence of elements of field F, and a surjective map from the list representation to F. For example, the difference representation (a,b) mapping to (a−b), is one such list representation, other examples are given herein.

Below a further sequence of operators is given that may also be used to create a sequence of operators so that the sequence for the field multiplication is the same as the sequence for the field addition in two encodings.

For example, let F by a field and let a, b, c, d ∈F. Two elements x and y are represented as the pairs (a,b) and (c,d) using the interpretation x=a−b; y=c−d. Note the following derivation

$$\begin{matrix}x + y = ( a - b ) + ( c - d ) \\ = a + c - b - d \\ = ( {ab}^{- 1} + {cb}^{1} - 1 ) b - d \\ = ( e - f ) b - d \\ = eb - fb - d \\ = - 1 ( fb + d - eb ) \\ = - 1 ( {fbb}^{- 1} {e}^{- 1} + {db}^{- 1 } e - 1 ) eb \\ = - 1 ( g - h ) eb \\ = ( h - g ) eb \\ = ( heb - geb )\end{matrix}$$

The latter may be written again a pair (heb, geb). In this example, we define the box operator □(a,b)=a+b−1=e−f. For the calculation (a,b)+(c,d), first we compute (x₁,x₂)=∇_{b} □Δ_{b} ((a,c)). From this the result of (a,b)+(c,d) may be computed as −∇ₓ_{₁} □Δₓ_{₁} ((x₂, d). The multiplication may be performed using the same operators but in the second encoding. Also this representation could be adapted for multiplication in the first encoding type, using the identity (a,b)·(c,d)=(ac,ad)+(bd,bc).

In an embodiment, elements of the field F may be encoded using different encodings. In the following example, two different representations of field elements are mixed. Let x=[α,Δ₀]ᵤ=u^{α+Δ}^{₀}−u^{α}, and y=(σ,τ)ᵤ=u^{σ}−u^{τ}. We define the box operator (in this example notated as [symbol] ) as [symbol] (α,Δ₀)=[β,Δ₁]ᵤ, wherein u^{Δ}^{₀}+u^{α}−1=u^{β}−^{β+Δ}^{₁}. In the table below, the derivation is shown on the left, and operators are shown in on the right.

| | |
|---|---|
| x + y = (u^{α+Δ}₀ − u^{α}) + (u^{σ} − u^{τ}) | [α, Δ₀]ᵤ + (σ, τ)ᵤ |
| = u^{α+Δ}₀ − u^{α} + u^{σ} − u^{τ} | |
| = u^{α}(u^{Δ}₀ + u^{σ-α} − 1) − u^{τ} | Δ_{α}(σ, τ)ᵤ = (σ − α, τ − α)ᵤ |
| = u^{α}(u^{β} − u^{β+Δ}₁) − u^{τ} | [symbol] (σ − α, Δ₀) = (β, Δ₁)ᵤ |
| = u^{α+β} − u^{α+β+Δ}₁ − u^{τ} | |
| = −1(u^{α+β+Δ}₁ + u^{τ} − u^{α+β}) | Δ_{β} ∘ Δ_{α}(σ, τ)ᵤ = (σ − α − β, |
| | τ − α − β)ᵤ |
| = −1 · u^{α+β}(u^{Δ}₁ + u^{τ-α-β} − 1) | [symbol] (τ − α − β, Δ₁) = (γ, Δ₂)ᵤ |
| = −1 · u^{α+β}(u^{γ} − u^{γ+Δ}₂) | |
| = −1(u^{α+β+γ} − u^{α+β+γ+Δ}₂) | |
| = u^{α+β+γ+Δ}₂ − u^{α+β+γ} | |
| = (α + β + γ, Δ₂)ᵤ | ∇_{α} ∘ ∇_{β} ∘ [symbol] (τ − α − β, Δ₁) |

Calculation device 100 may comprise an input interface arranged to receive a first encoded field element and a second encoded field element, both encoded according to the first or second encoding. The input interface may take various forms, such as a network interface to a local or wide area network, e.g., the Internet, a storage interface to an internal or external data storage, etc.

Typically, the device 100 comprises a microprocessor (not separately shown in FIG. 1) which executes appropriate software stored at the device 100; for example, that software may have been downloaded and/or stored in a corresponding memory, e.g., a volatile memory such as RAM or a non-volatile memory such as Flash (not separately shown). Alternatively, the device 100 may, in whole or in part, be implemented in programmable logic, e.g., as field-programmable gate array (FPGA). Device 100 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, device 100 comprises an operand store circuit, an operator module circuit, and a calculation manager circuit. The circuits implement the corresponding units described herein. The circuits may be a processor circuit and storage circuit, the processor circuit executing instructions represented electronically in the storage circuits. The circuits may also be, FPGA, ASIC or the like. The operand store circuit, an operator module circuit may be an electronic storage, e.g., an electronic memory.

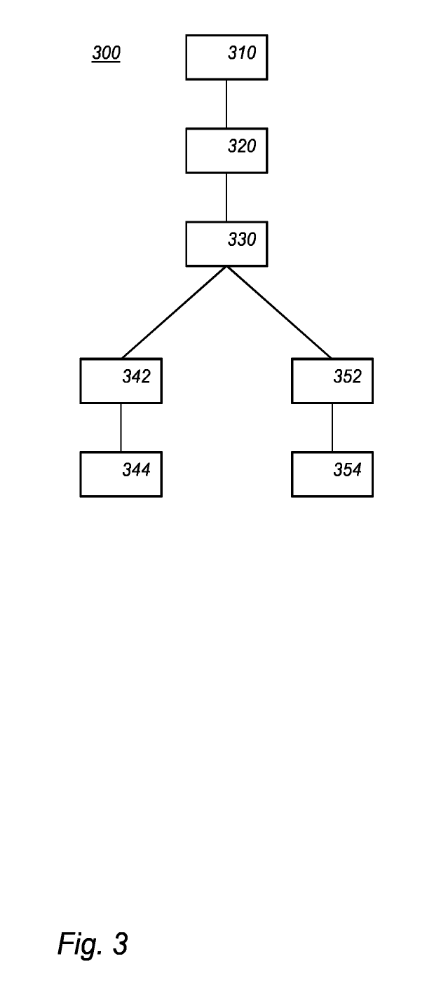

FIG. 3 illustrates as a schematic flowchart a calculation method 300 arranged to perform calculations on elements of a field. The method comprises
storing 310 encoded field elements (112, 114, 116; 212), an encoded field element representing an element of the field in encoded form, wherein an encoded field element is encoded according to one of at least two different encodings. For example, the encoded field elements may be stored in a memory, e.g., a volatile memory, e.g., a cloud storage etc.
a first encoding of the at least two different encodings wherein the encoded field element (x) is represented
a second encoding of the at least two different encodings wherein the encoded field element is represented as an exponent (s), the encoded field element being a generator (g) of the field to the power of the exponent (x=g^{s}),

The method further comprises
receiving 320 a first encoded field element and a second encoded field element, both encoded according to the first or second encoding, these encoded elements may be some of the elements stored during storing 310.

The method selects 330 whether to add or multiply the first encoded field element ((a,b)) and the second encoded field element ((c,d)). For example, a sequence of operators may be executed, e.g., as part of a computer program. The method further comprises:
for adding: apply 342 a second translation operator unit to any encoded field element encoded according to the second encoding, and apply 344 a set of addition operator units, the second translation operator unit arranged to receive a field element encoded according to the second encoding, and to produce the same field element re-encoded according to the first encoding, the set (128) of addition operator units being arranged to add two field elements encoded according to the first encoding,
for multiplication: apply 352 a first translation operator unit to any encoded field element encoded according to the first encoding, and apply 354 a set of multiplication operator units, the first translation operator unit arranged to receive a field element encoded according to the first encoding, and to produce the same field element re-encoded according to the second encoding, the set (129) of multiplication operator units being arranged to multiplying the two field elements encoded according to the second encoding by adding the exponents.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. A given step may not have finished completely before a next step is started.

A method according to the invention may be executed using software, which comprises instructions for causing a processor system to perform method 300. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bit stream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

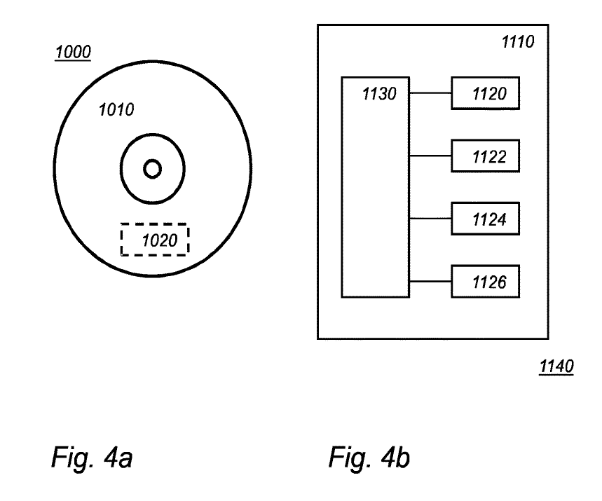

FIG. 4a shows a computer readable medium 1000 having a writable part 1010 comprising a computer program 1020, the computer program 1020 comprising instructions for causing a processor system to perform a calculation method, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said method of calculation.

FIG. 4b shows in a schematic representation of a processor system 1140 according to an embodiment. The processor system comprises one or more integrated circuits 1110. The architecture of the one or more integrated circuits 1110 is schematically shown in FIG. 4b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the calculation device may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. The calculation device may comprise a non-volatile software interface, e.g., a hard drive, a network interface, etc., arranged for providing the software. The processor circuit may comprise multiple processor cores cooperating to execute the software.

The following clause relates to various embodiments of the invention. The Applicant hereby gives notice that new claims may be formulated to such clauses and/or combinations of such clauses and/or features taken from the description, during prosecution of the present application or of any further application derived therefrom.

Clause 1: A calculating device (100) arranged to perform calculations on elements of a field (F), a field addition and a field multiplication being defined on the field, the calculating device comprising
an operand store (110) arranged to store encoded field elements (112, 114, 116; 212), an encoded field element representing an element of the field in encoded form, wherein an encoded field element is encoded according to one of at least two different encodings,
   a first encoding of the at least two different encodings wherein the encoded field element (x) is represented
   a second encoding of the at least two different encodings wherein the encoded field element is represented as an exponent (s), the encoded field element being a generator (g) of the field to the power of the exponent (x=g^{s}),
an operator module (120; 220) comprising multiple operator units, the multiple operator units comprising
   a first translation operator unit arranged to receive a field element encoded according to the first encoding, and to produce the same field element re-encoded according to the second encoding,
   a second translation operator unit arranged to receive a field element encoded according to the second encoding, and to produce the same field element re-encoded according to the first encoding,
   a set (128) of addition operator units, the set of addition operator units being arranged to add two field elements encoded according to the first encoding, and
   a set (129) of multiplication operator units, the set of multiplication operator units being arranged to multiplying the two field elements encoded according to the second encoding by adding the exponents,|
a calculation manager (130) arranged to
   receive a first encoded field element and a second encoded field element, both encoded according to the first or second encoding,
   selectively add or multiply the first encoded field element ((a,b)) and the second encoded field element ((c,d)), by
      for adding: apply the second translation operator unit to any encoded field element encoded according to the second encoding, and apply the set of addition operator units, and
      for multiplication: apply the first translation operator unit to any encoded field element encoded according to the first encoding, and apply the set of multiplication operator units.

Clause 2: 11. A calculating device according to Clause 1, wherein the list of two field elements in a first and/or second encoding is represented as exponents ((α,β)), the two field elements being the exponent of a common base element (u) of the field raised to the power indicated by the exponent (x=u^{α}−u^{β}).

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of embodiments or to formulas of embodiments, thus increasing the intelligibility of the claim. These references shall not be construed as limiting the claim.

### LIST OF REFERENCE NUMERALS IN FIGS. 1-2b

100 a calculating device
110 an operand store
112, 114, 116 an encoded field element
120 an operator module
122.1, 122.2 a dyadic operator unit
123.1, 123.2 a monadic operator unit
124 a first translation operator unit
125 a second translation operator unit
128 a set of addition operator units
129 a set of multiplication operator units
130 a calculation manager
132 a sequence of operators
212 an encoded field element
213, 215 a field element
232 an encoded field element
233, 235 a field element
220 an operator module
222.1, 222.2, Δ a dyadic up operator unit
224.1, 224.2, ∇ a dyadic down operator unit
226.1, 226.2, □ a monadic box operator unit
228 a set of addition operator units
229 a set of multiplication operator units

1. A calculating device arranged to perform calculations on elements of a field (F), a field addition and a field multiplication being defined on the field, the calculating device comprising
an operand store arranged to store encoded field elements, an encoded field element representing an element of the field in encoded form, wherein an encoded field element is encoded according to one of at least two different encodings,
a first encoding of the at least two different encodings wherein the encoded field element (x) is represented, the encoded field element in the first encoding being represented as a list of two elements (a,b), the encoded field element being the difference between said two elements (x=a−b),
a second encoding of the at least two different encodings wherein the encoded field element is represented as a list of two elements ((c,d)) representing an exponent (s), the encoded field element being a generator (g) of the field to the power of the difference between said two elements (x=g^{s}; x=g^{c-d}), at least some field elements in the operand store are encoded according to the first encoding and at least some according to the second encoding to hide the calculations performed thereon,
an operator module comprising multiple operator units, the multiple operator units comprising
a first translation operator unit arranged to receive a field element encoded according to the first encoding, and to produce the same field element re-encoded according to the second encoding,
a second translation operator unit arranged to receive a field element encoded according to the second encoding, and to produce the same field element re-encoded according to the first encoding,
a set of addition operator units, the set of addition operator units being arranged to add two field elements encoded according to the first encoding, and
a set of multiplication operator units, the set of multiplication operator units being arranged to multiplying the two field elements encoded according to the second encoding by adding the exponents,
a calculation manager arranged to
receive a first encoded field element and a second encoded field element, both encoded according to the first or second encoding from the operand memory,
selectively add or multiply the first encoded field element ((a,b)) and the second encoded field element ((c,d)), by
for adding: apply the second translation operator unit to any encoded field element encoded according to the second encoding, and apply the set of addition operator units, and
for multiplication: apply the first translation operator unit to any encoded field element encoded according to the first encoding, and apply the set of multiplication operator units.

2. (canceled)

3. A calculation device according to claim 1, wherein the set of addition operator units and the set of multiplication operator units comprise at least one
a dyadic operator unit arranged to
receive an encoded field element and a parameter, and
perform a fixed calculation on said encoded field element and the parameter, thus producing a new encoded field element.

4. A calculation device according to claim 1, wherein
the first and second translation operator unit are monadic, and/or
at least one operator unit of the set of addition operator units and of the set of multiplication operator units is monadic,
a monadic operator unit being arranged to
receive an encoded field element, and
perform a fixed calculation on said encoded field element, thus producing a new encoded field element.

5. A calculation device according to claim 1, wherein a first one-to-one mapping is defined between the set of addition operator units and the set of multiplication operator units, a sequence of operating units in the set of addition operator units applied for adding being mapped one-to-one by the first mapping to a sequence of operating units in the set of multiplication operator units applied for multiplication.

6. A calculation device according to claim 1, wherein a second one-to-one mapping is defined between the input elements, output elements and parameters of the dyadic operators in the set of addition operator units and the input elements, output elements and parameters of the dyadic operators in the set of multiplication operator units.

7. A calculating device according to claim 1, wherein
the set of addition operator units and the set of multiplication operator units comprises a dyadic up operator unit, the up operator unit being arranged to
receive a field element (x) encoded according to the first or second encoding, the encoding comprising a representation for a first field element (a) and a second field element (b), and to receive a parameter field element (c), and
calculate the first field element field multiplied with the inverse of the parameter (ac⁻¹) and calculate the second field element field multiplied with the inverse of the parameter (bc⁻¹), the new encoded field element (y) being represented by the results of said two calculations (y=ac⁻¹−bc⁻¹), and/or
the set of addition operator units and the set of multiplication operator units comprises a dyadic a dyadic down operator unit, the down operator unit being arranged to
receive a field element (x) encoded according to the first or second encoding, the encoding comprising a representation for a first field element (a) and a second field element (b), and to receive a parameter field element (c), and
calculate the first field element field multiplied with the parameter (ac) and calculate the second field element field multiplied with the parameter (bc), the new encoded field element (y) being represented by the results of said two calculations (y=ac−bc).

8. A calculating device according to claim 1, wherein the set of addition operator units and the set of multiplication operator units comprises a monadic box operator unit, the box operator unit being arranged to
receive a field element (x) encoded according to the first or second encoding, the encoding comprising a representation for a first field element (a) and a second field element (b), and to receive a parameter field element (c), and
obtain the negation of the encoded field element (x) plus a fixed increment (−(x+1=−x−1) in encoded form.

9. A calculating device according to claim 7, wherein a first encoded field element ((a,b)) after translation if needed comprises a representation for a first first field element (a) and a first second field element (b), and the second encoded field element ((c,d)), after translation if needed, a representation for a second first field element (c) and a second second field element (d), applying the set of addition operator units and applying the set of multiplication operator units comprises
the up operator unit with parameter the second first field element (c),
the box operator unit
the down operator unit with parameter the second first field element (c),
the up operator unit with parameter the second second field element (d),
the box operator unit
the down operator unit with parameter the second second field element (d).

10. A calculating device according to claim 1, wherein the operator module comprises a storage storing a look-up tables implementing of the multiple operator units.

11. A calculating device according to claim 1, wherein the list of two field elements in a first encoding is represented as exponents ((α,β)), the two field elements being the exponent of a common base element (u) of the field raised to the power indicated by the exponent (x=u^{α}−u^{β}).

12. A calculating device according to claim 1, wherein an encoded field element encoded according to the second encoding represents the number 0, if the corresponding exponent (s) equals a special element (−∞).

13. A calculating device according to claim 12, wherein
the encoded field element in the second encoding is represented as a list of two elements ((c d)), an encoded field element being a generator (g) of the field to the power of the difference between said two elements (x=g^{c-d}).
the elements (c,d) in an encoded field element of the second type are restricted to a second encoding set consisting of: one or more units of [symbol] ₙ₋₁, wherein n is the number of elements of the field, and the special element, and wherein optionally
the elements in an encoded field element of the first type are restricted to a first encoding set, wherein the first encoding set is a difference set of the field, wherein the first and second encoding set have the same size.

14. A calculating device according to claim 1, wherein the operator module comprises
a first dummy translation operator unit arranged to receive a field element encoded according to the first encoding, and to produce the same field element re-encoded according to the first encoding, and/or
a second dummy translation operator unit arranged to receive a field element encoded according to the second encoding, and to produce the same field element re-encoded according to the second encoding.

15. A calculating device arranged to perform calculations on elements of a field (F), a field addition and a field multiplication being defined on the field, the calculating device comprising
an operand store arranged to store encoded field elements, an encoded field element representing an element of the field in encoded form, wherein an encoded field element is encoded according to one of at least two different encodings,
a first encoding of the at least two different encodings wherein the encoded field element (x) is represented, the encoded field element in the first encoding being represented as a list of two elements ((a,b)), the encoded field element being the difference between said two elements (x=a−b),
a second encoding of the at least two different encodings wherein the encoded field element is represented as a list of two elements ((c,d)) representing an exponent (s), the encoded field element being a generator (g) of the field to the power of the difference between said two elements (x=g^{s}; x=g^{c-d}), at least some field elements in the operand store are encoded according to the first encoding and at least some according to the second encoding to hide the calculations performed thereon,
an input interface arranged to receive a first encoded field element and a second encoded field element, both encoded according to the first or second encoding,
a processor circuit configured for
multiple operators, the multiple operators comprising
a first translation operator arranged to receive a field element encoded according to the first encoding, and to produce the same field element re-encoded according to the second encoding,
a second translation operator arranged to receive a field element encoded according to the second encoding, and to produce the same field element re-encoded according to the first encoding,
a set of addition operator s, the set of addition operator being arranged to add two field elements encoded according to the first encoding, and
a set of multiplication operator, the set of multiplication operator being arranged to multiplying the two field elements encoded according to the second encoding by adding the exponents, and
calculations, the calculations comprising
receiving a first encoded field element and a second encoded field element, both encoded according to the first or second encoding from the operand memory,
selectively add or multiply the first encoded field element ((a,b)) and the second encoded field element ((c,d)), by
for adding: apply the second translation operator unit to any encoded field element encoded according to the second encoding, and apply the set of addition operator units, and
for multiplication: apply the first translation operator unit to any encoded field element encoded according to the first encoding, and apply the set of multiplication operator units.

16. A calculating method arranged to perform calculations on elements of a field (F), a field addition and a field multiplication being defined on the field, the calculating device comprising
storing encoded field elements, an encoded field element representing an element of the field in encoded form, wherein an encoded field element is encoded according to one of at least two different encodings,
a first encoding of the at least two different encodings wherein the encoded field element (x) is represented, the encoded field element in the first encoding being represented as a list of two elements (a,b)), the encoded field element being the difference between said two elements (x=a−b),
a second encoding of the at least two different encodings wherein the encoded field element is represented as a list of two elements ((c,d)) representing an exponent (s), the encoded field element being a generator (g) of the field to the power of the difference between said two elements (x=g^{s}; x=g^{c-d}), at least some field elements are being stored encoded according to the first encoding and at least some according to the second encoding to hide the calculations performed thereon,
receive a first encoded field element and a second encoded field element, both being stored encoded according to the first or second encoding,
selectively add or multiply the first encoded field element ((a,b)) and the second encoded field element ((c,d)), by
for adding: apply a second translation operator unit to any encoded field element encoded according to the second encoding, and apply a set of addition operator units, the second translation operator unit arranged to receive a field element encoded according to the second encoding, and to produce the same field element re-encoded according to the first encoding, the set of addition operator units being arranged to add two field elements encoded according to the first encoding,
for multiplication: apply a first translation operator unit to any encoded field element encoded according to the first encoding, and apply a set of multiplication operator units, the first translation operator unit arranged to receive a field element encoded according to the first encoding, and to produce the same field element re-encoded according to the second encoding, the set of multiplication operator units being arranged to multiplying the two field elements encoded according to the second encoding by adding the exponents.

17. A computer readable medium comprising transitory or non-transitory data representing instructions to cause a processor system to perform the method according to claim 16.
